(19) United States
(12) Patent Application Publication
(10) Pub. No.: US 2026/0205914 A1
(43) Pub. Date: Jul. 16, 2026

(54) WI-FI ROAMING USING MACHINE LEARNING AND DYNAMIC DECISION MAKING

(71) Applicant: Samsung Electronics Co., Ltd., Suwon-si (KR)

(72) Inventors: Khuong N. Nguyen, Frisco, TX (US); Yuming Zhu, Plano, TX (US)

(21) Appl. No.: 19/440,580

(22) Filed: Jan. 5, 2026

Related U.S. Application Data
(60) Provisional application No. 63/744,967, filed on Jan. 14, 2025.

(51) Int. Cl. H04W 36/32; H04L 41/16; H04W 36/30

(52) U.S. Cl. CPC H04W 36/322; H04L 41/16; H04W 36/30

(57) ABSTRACT

A method includes determining Wi-Fi network conditions and user context based on a received a set of inputs including: a link quality, a location information, and a mobility context information. The method includes obtaining a first ML model related to the location information. The method includes determining a roaming action to roam from a first AP to a second AP or to not roam, based on providing the set of inputs to the first ML model. The method includes obtaining a second ML model related to the location information, based on a determination that the roaming action is the action to roam. The method includes providing a list of AP candidates as inputs to the second ML model to select an AP candidate as the second AP from among the list of AP candidates. The method includes connecting a Wi-Fi transceiver of the UE and the second AP selected.

### CROSS-REFERENCE TO RELATED APPLICATION(S) AND CLAIM OF PRIORITY

This application claims priority under 35 U.S.C. § 119(e) to U.S. Provisional Patent Application No. 63/744,967 filed on Jan. 14, 2025. The above-identified provisional patent application is hereby incorporated by reference in its entirety.

### TECHNICAL FIELD

This disclosure relates generally to wireless communication systems. More specifically, this disclosure relates to Wi-Fi roaming using machine learning and dynamic decision making.

### BACKGROUND

In the context of Wi-Fi roaming, the seamless transition between access points (APs) is critical for maintaining connectivity and ensuring optimal network performance, particularly in environments with high mobility, such as offices, campuses, or urban areas. Existing legacy solutions often rely on simplistic criteria like signal strength, which can lead to suboptimal connections and degraded user experiences due to congestion or interference.

### SUMMARY

This disclosure provides Wi-Fi roaming using machine learning and dynamic decision making, which enables efficient roaming and seamless handoff in dense environments with multiple overlapping Wi-Fi access points.

In one embodiment, a method for intelligent Wi-Fi roaming using machine learning and dynamic decision making is provided. The method includes determining Wi-Fi network conditions and user context based on a received a set of inputs. The set of inputs including: a link quality, a location information, and a mobility context information. The method includes obtaining a first machine learning (ML) model related to the location information. The method includes determining a roaming action from among an action to roam from a first access point (AP) currently connected to a user equipment (UE) to a second AP or an action to not roam, based on providing the set of inputs to the first ML model. The method includes obtaining a second ML model related to the location information, based on a determination that the roaming action is the action to roam. The method includes providing a list of AP candidates as inputs to the second ML model to select an AP candidate as the second AP from among the list of AP candidates. The method includes establishing a connection between a Wi-Fi transceiver of the UE and the second AP selected.

In another embodiment, an electronic device for intelligent Wi-Fi roaming using machine learning and dynamic decision making is provided. The electronic device is a user equipment (UE) comprising a Wi-Fi transceiver and a processor operably connected to the Wi-Fi transceiver. The processor is configured to determine Wi-Fi network conditions and user context based on a received a set of inputs. The set of inputs includes: a link quality, a location information, and a mobility context information. The processor is configured to obtain a first machine learning (ML) model related to the location information. The processor is configured to determine a roaming action from among an action to roam from a first access point (AP) currently connected to the UE to a second AP or an action to not roam, based on providing the set of inputs to the first ML model. The processor is configured to obtain a second ML model related to the location information, based on a determination that the roaming action is the action to roam. The processor is configured to provide a list of AP candidates as inputs to the second ML model to select an AP candidate as the second AP from among the list of AP candidates. The processor is configured to establish a connection between the Wi-Fi transceiver and the second AP selected.

In yet another embodiment, a non-transitory computer readable medium comprising program code for intelligent Wi-Fi roaming using machine learning and dynamic decision making is provided. The computer program includes computer readable program code that when executed causes at least one processor to determine Wi-Fi network conditions and user context based on a received a set of inputs. The set of inputs includes: a link quality, a location information, and a mobility context information. The computer readable program code causes the processor to determine Wi-Fi network conditions and user context based on a received a set of inputs. The computer readable program code causes the processor to obtain a first machine learning (ML) model related to the location information. The computer readable program code causes the processor to determine a roaming action from among an action to roam from a first access point (AP) currently connected to the UE to a second AP or an action to not roam, based on providing the set of inputs to the first ML model. The computer readable program code causes the processor to obtain a second ML model related to the location information, based on a determination that the roaming action is the action to roam. The computer readable program code causes the processor to provide a list of AP candidates as inputs to the second ML model to select an AP candidate as the second AP from among the list of AP candidates. The computer readable program code causes the processor to establish a connection between a Wi-Fi transceiver of the UE and the second AP selected.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIG. 2A illustrates an example access point (AP) according to this disclosure;

FIG. 2B illustrates an example station (STA) according to this disclosure;

FIG. 3 illustrates a dense environment including multiple overlapping Wi-Fi access points where a user equipment (UE) experiences a Wi-Fi roaming problem according to this disclosure;

FIG. 4A illustrates an Intelligent Wi-Fi Roamer (IWR) system according to embodiments of this disclosure;

FIG. 4B illustrates the Wi-Fi network of FIG. 4A;

FIG. 5 illustrates a roaming trigger module according to embodiments of this disclosure;

FIG. 6 illustrates an example RT module that implements a Supervised Learning system according to embodiments of this disclosure;

FIG. 7 illustrates an example RT module that implements a Reinforcement Learning (RL) system 700 according to embodiments of this disclosure;

FIG. 8A illustrates the access point selector module (APSM) implementing a rule-based system according to embodiments of this disclosure;

FIG. 8B illustrates the APSM implementing an ML-based model according to embodiments of this disclosure; and

FIG. 9 illustrates a method for intelligent Wi-Fi roaming using machine learning and dynamic decision in accordance with an embodiment of this disclosure.

### DETAILED DESCRIPTION

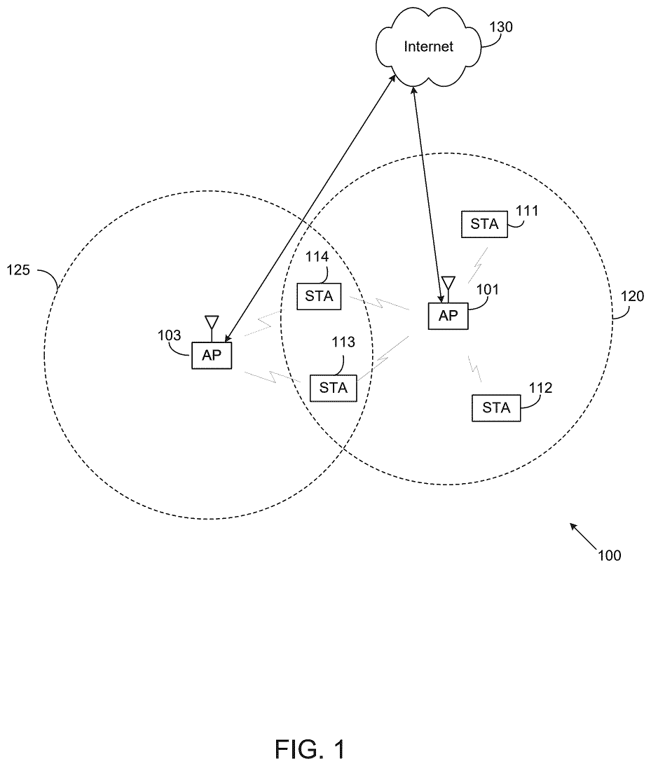

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication system or device.

Suboptimal connections and degraded user experiences due to congestion or interference are outcomes of solutions that rely on basic criteria such as signal strength for determining Wi-Fi roaming actions. These suboptimalities and degradations highlight problems that this disclosure solves. This disclosure provides an intelligent system that dynamically detects when a user equipment (UE) should roam and identifies an optimal AP to roam to by considering multiple factors, such as network load, latency, and user application designs. This disclosure provides an intelligent system that performs efficient roaming and seamless handoff in dense environments with multiple overlapping access points.

Some of the other potential problems that are solved by the embodiments of this disclosure include: (1) Seamless Roaming; (2) Suboptimal AP Selection; (3) Dynamic Network Environments; and (4) Battery and Resource Efficiency. A problem with seamless roaming occurs when users experience interruptions during AP transitions, especially in high-mobility scenarios. This challenge of enabling smooth, uninterrupted handoffs to maintain consistent connectivity is solved by embodiments of this disclosure. A problem of suboptimal AP selection occurs when systems rely solely on signal strength to determine Wi-Fi roaming actions, and thereby ignore factors like network congestion, latency, and interference, which can cause poor user experiences. This disclosure solves the problem of suboptimal AP selection by integrating a multi-metric evaluation system. Dynamic network environments is a challenge in which Wi-Fi networks are highly dynamic, with constantly changing conditions due to user mobility and varying device densities. This disclosure solves the challenge of real-time decision-making to adapt to these changes effectively. Battery and resource efficiency is a challenge when frequent scanning and frequent transitions between APs drain batteries of an electronic device and consume computational resources. This disclosure solves this challenge by optimizing the roaming process to minimize resource usage. By addressing these problems, this disclosure significantly improves Wi-Fi roaming, ensuring robust and efficient network performance in diverse environments. Embodiments of this disclosure enhance network reliability, reduces downtime, and significantly improves the quality of service for end-users, meeting the growing demands of modern wireless communication.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for intelligent Wi-Fi roaming using machine learning and dynamic decision making, which enables efficient roaming and seamless handoff in dense environments with multiple overlapping Wi-Fi access points. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

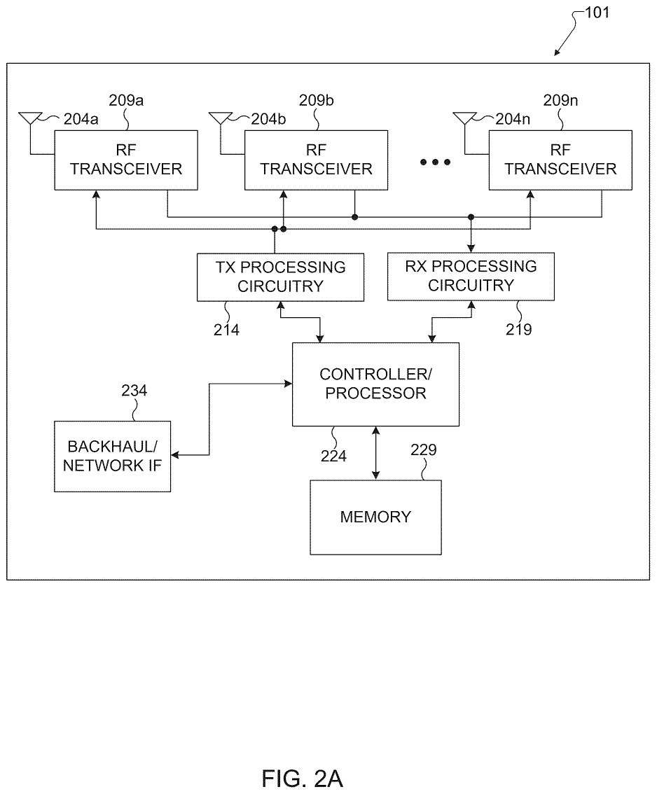

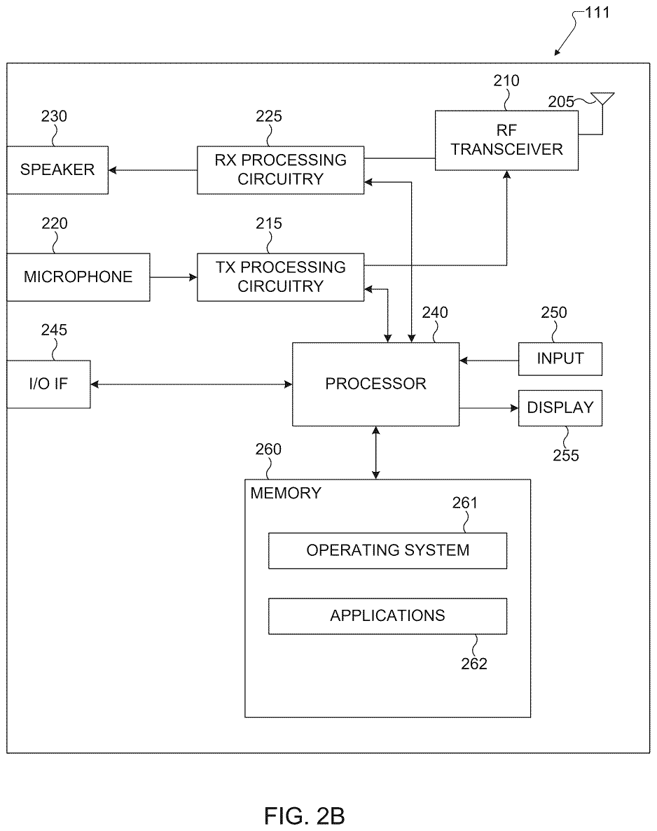

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including functions for intelligent Wi-Fi roaming using machine learning and dynamic decision making, which enables efficient roaming and seamless handoff in dense environments with multiple overlapping Wi-Fi access points. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for intelligent Wi-Fi roaming using machine learning and dynamic decision making, which enables efficient roaming and seamless handoff in dense environments with multiple overlapping Wi-Fi access points. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in other APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured for intelligent Wi-Fi roaming using machine learning and dynamic decision making, which enables efficient roaming and seamless handoff in dense environments with multiple overlapping Wi-Fi access points. In some embodiments, the controller/processor 240 includes at least one microprocessor or microcontroller.

The controller/processor 240 is also capable of executing other processes and programs resident in the memory 260, such as operations for intelligent Wi-Fi roaming using machine learning and dynamic decision making, which enables efficient roaming and seamless handoff in dense environments with multiple overlapping Wi-Fi access points. The controller/processor 240 can move data into or out of the memory 260 as required by an executing process. In some embodiments, the controller/processor 240 is configured to execute a plurality of applications 262, such as applications that include an Intelligent Wi-Fi Roamer (IWR) system as described further in this disclosure. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

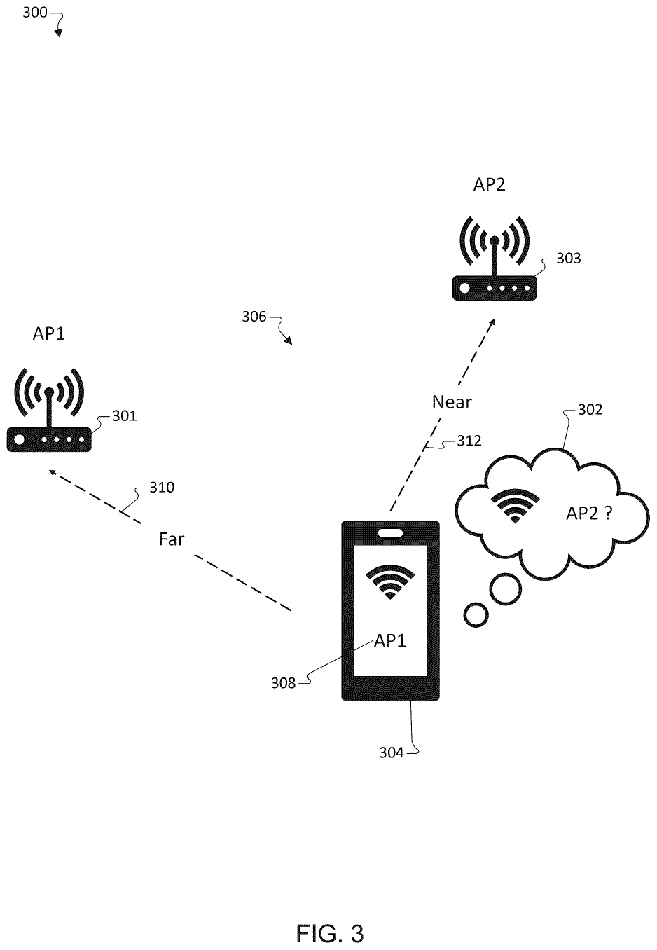

FIG. 3 illustrates a dense environment 300 including multiple overlapping Wi-Fi access points 301 and 303 where a user equipment (UE) experiences a Wi-Fi roaming problem 302 according to this disclosure. Embodiments of this disclosure enables the UE to solve this Wi-Fi roaming problem. The AP 301, AP 303, and UE 304 can be the same as or similar to the AP 101, AP 103, and STA 114 of FIG. 1. In this embodiment, the multiple overlapping Wi-Fi access points 301 and 303 are within the same wireless network, which can be the same as or similar to the wireless network 100 of FIG. 1.

The dense environment includes an overlapping coverage are 306 where coverage areas of the APs 301 and 303 overlap, such as where the coverage areas 120 and 125 overlap in FIG. 1. The UE 304 is currently connected to a first AP 301, as indicated by the Wi-Fi icon 308 displayed on a screen of the UE 304. The location of the UE 304 is within an overlapping coverage area 306, where the UE 304 may detect weak link quality from the currently connected AP 101 due to a far distance 310 between the locations of AP 101 and the UE 304. Also within the overlapping coverage area 306, the UE 306 may detect a stronger link quality from the second AP 303 due to a near proximity to the second AP 303. The Wi-Fi roaming problem 302 is determining whether to roam to the second AP 303. In other words, the Wi-Fi roaming problem 302 determines whether the UE 306 can move between the coverage areas of multiple APs 301 and 303 within the same wireless network without losing connectivity.

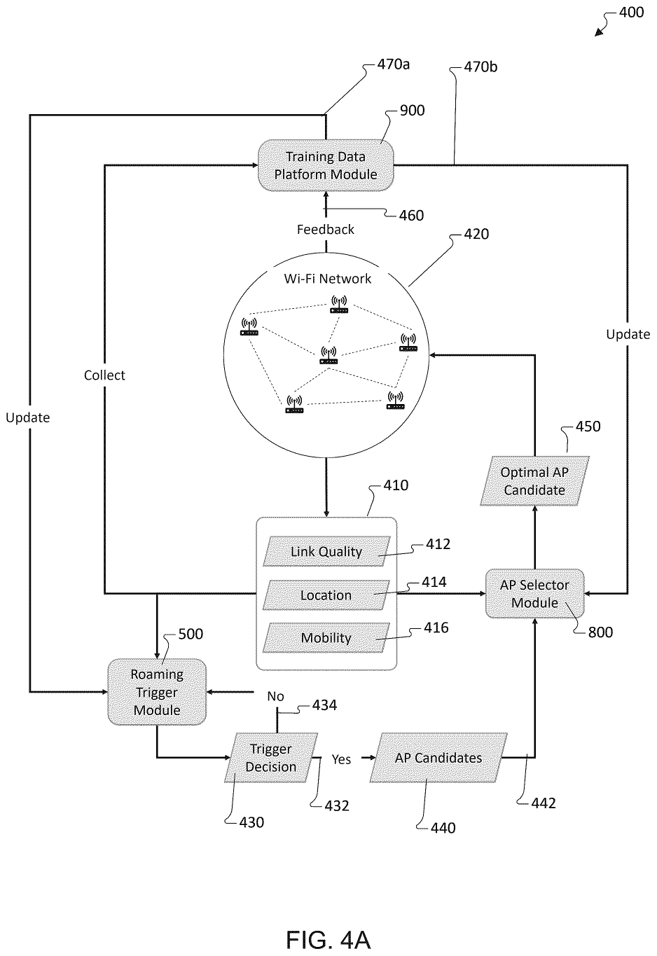

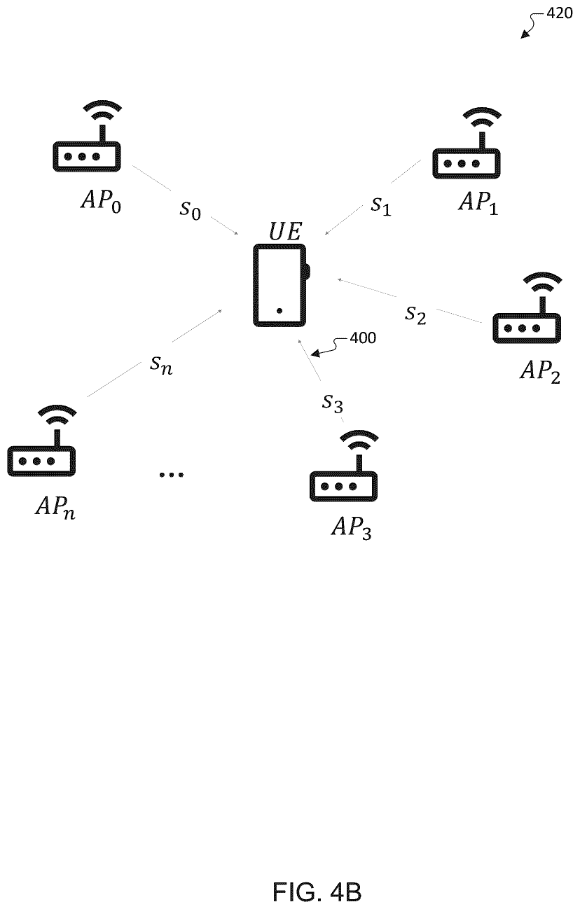

FIG. 4A illustrates an Intelligent Wi-Fi Roamer (IWR) system 400 according to embodiments of this disclosure. The embodiment of the IWR system 400 shown in FIG. 4A is for illustration only, and other embodiments could be used without departing from the scope of this disclosure. The IWR system 400 is the circuitry and/or programming for intelligent Wi-Fi roaming using machine learning and dynamic decision making, which enables efficient roaming and seamless handoff in dense environments with multiple overlapping Wi-Fi access points. The IWR system 400 could be included within a STA, such as any among the plurality of STAs 111-114 of FIG. 1 or the UE 304 of FIG. 3.

The IWR system 400 includes circuitry and/or programming that configures a STA to perform seamless, efficiently Wi-Fi roaming to maintain uninterrupted connectivity in Wi-Fi networks, especially in dense environments with multiple overlapping APs. The IWR system 400 employs reinforcement learning to learn site-specific characteristics of frequently connected Wi-Fi networks and uses user-device sensor data to decide when the UE should roam and to select the AP to roam to in order to maintain a seamless Wi-Fi connection experience.

The IWR system 400 receives a set of inputs 410 including: a link quality 412, a location information 414, and a mobility information 416. The set of inputs 410 is received from a Wi-Fi network 420 that includes multiple overlapping Wi-Fi access points, such as the overlapping APs 101 and 103 of FIG. 1, or the overlapping APs 301 and 303 of FIG. 3. The set of inputs 410 can be extracted from a Wi-Fi scan result. The IWR system 400 depends upon the link quality 412, a location information 414, and a mobility information 416 as three primary input components to determine (for example, to make informed decisions about) when and where to roam. Each primary input component provides data points that enable the IWR system 400 to achieve a nuanced understanding of the user's connectivity environment and movement.

The link quality 412 includes captures of real-time metrics that represent the current state of the Wi-Fi connection and the surrounding radio environment. These measurements are retrieved from the currently associated AP within the Wi-Fi network 420, and these link quality 412 measurements include: Received Signal Strength Indicator (RSSI), Estimated Throughput (ETP), Clear Channel Assessment (CCA) Busy Time, Radio On (RO) Time, Channel Contention Level, and Packet Delay (D). The ETP is a calculated value as a prediction of the maximum data transmission rate based on current conditions. The CCA busy time represents the proportion of time the channel is sensed as busy, reflecting interference and congestion. The RO time measures the total active duration of the radio interface, helping to understand channel utilization. The channel contention level is calculated as the ratio of CCA to RO, and this metric estimates the level of contention in the channel. The packet delay is a measurement of the latency experienced in the current connection, indicating the responsiveness of the network.

The location information 414 includes location data and provides spatial context to assist the IWR system 400 in decision-making, particularly in environments where different APs are geographically distributed. The location information 414 includes geo-location data and location context. The geo-location data can be obtained from a GPS receiver or other location-detection mechanisms. The geo-location data helps in understanding the user's current position and proximity to available APs. The location context can be a Service Set Identifier of the Wi-Fi Network (Wi-Fi Network SSID). The location information 414 can include a current location of the UE based on geo-location data and location context.

The mobility information 416 enhances the IWR system's 400 understanding of the user's movement patterns, which are utilized for anticipating changes in connectivity requirements of the UE or applications executed on the UE. The mobility information 416 includes inertial measurement unit (IMU) sensors data, and refined mobility context. The IMU sensors data captures motion and orientation details from sensors such as accelerometers, gyroscopes, and magnetometers, thereby providing raw mobility insights. The refined mobility context combines raw IMU data with additional processing and context to classify mobility states, thereby aiding IWR system 400 in predictive decision-making. The refined mobility context can classify mobility states that indicate whether a user is stationary, walking, or running.

The IWR system 400 includes a roaming trigger (RT) module 500, an access point selector module (APSM) 800, and a data platform (DP) module 900. In this disclosure, the data platform (DP) module 900 is also referred to as a training data platform module.

Initially, the RT module 500 monitors link quality 412, location information 414, and mobility context (obtained from mobility information 416) as a basis for evaluating current network conditions and user context. That is, RT module 500 evaluates current network conditions and user context, and determines when to initiate a roaming process based on results of the evaluation. The RT module 500 generates and outputs a trigger decision 430, which can be a trigger decision to roam 432 or a trigger decision to not roam 434.

If roaming is triggered, then the IWR system 400 conducts a Wi-Fi scan to discover identities of available potential AP candidates 440 within range. Conducting this scan consumes resources, such as computational resources, time, and battery power. The scan results are filtered to create a shortlist 442 of preferred AP candidates. The maximum quantity of AP candidates that the shortlist 442 can hold is a configurable number n, for example, a default number can be four (n=4). In some embodiments, the trigger decision 430 controls the APSM 800 such that trigger decision to roam 432 activates the APSM 800 to initiate operations such as triggering a Wi-Fi scan to be conducted, but the trigger decision to not roam 434 does not activate the APSM 800.

The APSM 800 evaluates these candidates among the shortlist 442 using the same combined set of inputs 410 to select an optimal AP 450 (for example, most suitable AP) for achieving a seamless and efficient transition. The APSM 800, by selecting an optimal AP 450 to which to roam, ensures that the selected AP will provide the optimal performance.

In the meantime, the DP module 900 operates in the background, routinely collecting log data from interactions with the Wi-Fi network 420. In some embodiments, the same set of inputs 410 includes the log data that the DP module 900 collects. The DP module 900 processes (for example, combines) the collected data with feedback data 460 from the network 420 to generate updates 470a-470b that enhance the decision-making capabilities of both the RT module and APSM 500 and 800. The feedback 460 from the network can include connection quality and user experience metrics. The updates 470a-470b can refine and update machine learning models within the RT module 500 and APSM 800, which is a continuous learning process adapts the IWR system 400 to dynamic network environments and changes in network conditions, and enables the IWR system 400 to improve over time. In some embodiments, the DP module 900 filters the scan results, creates the shortlist 442 including identifiers (IDs) from the AP candidates 440, and incorporates the shortlist 442 into the update 470b for the APSM 800.

FIG. 4A and FIG. 4B are referred to as FIG. 4 in this disclosure. FIG. 4B illustrates the Wi-Fi network 420 of FIG. 4A. The Wi-Fi network 420 includes a set of Wi-Fi access points {AP₀, AP₁, AP₂, AP₃, . . . APₙ} having respective coverage areas that overlap each other. The user equipment (UE) shown in FIG. 4B is a STA that includes the IWR system 400, and the location of this UE is within an overlapping coverage area where the UE receives a state variable {s₀, s₁, s₂, s₃, . . . sₙ} from each among set of Wi-Fi access points {AP₀, AP₁, AP₂, AP₃, . . . APₙ}, respectively.

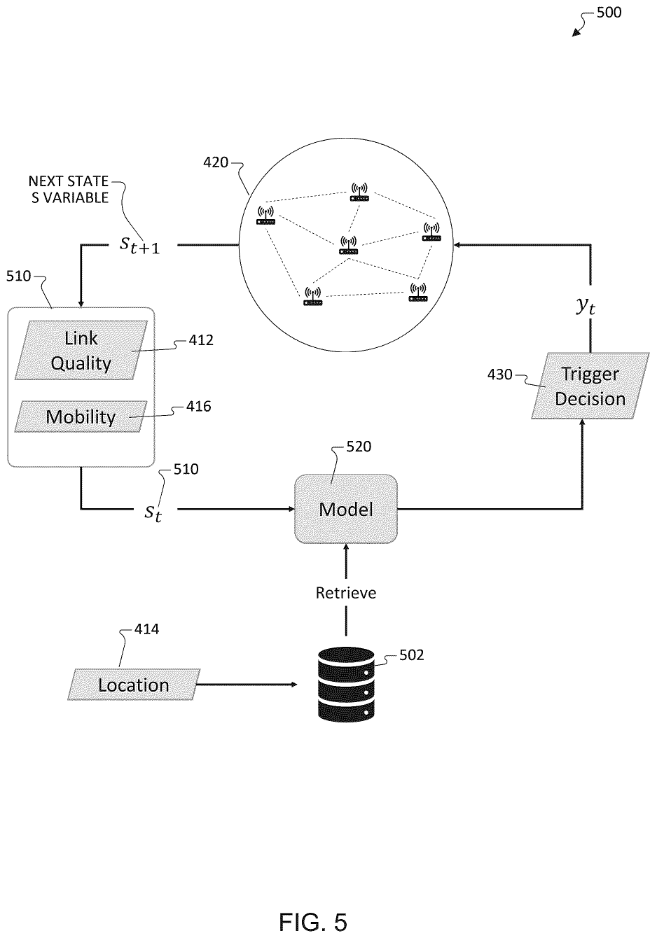

FIG. 5 illustrates a roaming trigger module 500 according to embodiments of this disclosure. The embodiment of the RT module 500 shown in FIG. 5 is for illustration only, and other embodiments could be used without departing from the scope of this disclosure.

Each of the components and operations of the RT module 500 shown in FIG. 5 can be the included within the RT module 500 shown in FIG. 4. For example, the RT module 500 in FIG. 5 receives and processes the set of inputs 410 and outputs the trigger decision 430 of FIG. 4.

The RT module 500 includes a model storage 502 such as a database in which each location-specific model is linked to a location 414. The location-specific model can be a machine learning (ML) model. Location information 414 serves as the identifier (ID) for identifying the appropriate model corresponding to a specific geographic or network context.

The RT module 500 determines whether a model related to a current location of the UE is stored in the model storage 502, for example, by querying the database. The RT module 500 selects and retrieves a location-specific model 520 that is linked to the location 414.

The RT 500 is designed for scalability, enabling the RT 500 to manage multiple Wi-Fi networks simultaneously. The RT 500 utilizes location-specific models to process input data and produce corresponding decisions tailored to individual networks. That is, the RT module 500 inputs a current state variable (sₜ) 510 into the selected model 520 that is configured and trained to generate a roaming trigger decision (yₜ) 430 based on the sₜ 510. The current state variable (sₜ) 510 represents or includes the link quality 412 and mobility information 416, which is a subset of the set of inputs 410. The trigger decision (yₜ) 430 can be a binary value, such as a first value (yₜ=1) that represents a decision to roam 432 or a second value (yₜ=0) that represents a decision to not roam 434.

In this disclosure, t denotes time, such as the current time, and t+1 denotes a future time after the UE has executed the action to roam to the different AP or has executed the action to not roam to maintain the connection to the currently-connected AP. The next state variable (sₜmi) another set of inputs captured at the future time.

The RT 500 can be implemented using a variety of machine learning techniques. In this example, the RT 500 operates in two distinct modes: Inference Mode and Training Mode. In the inference mode, the RT module 500 receives combined input data from the Wi-Fi network, including link quality, location information, and mobility context. Using this input data, the selected module 520 of RT module processes and determines whether to initiate a roaming action.

When a UE initially connects to a new Wi-Fi network (for example, an unseen Wi-Fi network), the RT 500 remains dormant during a predefined initial phase. This initial phase allows the DP module 900 to collect sufficient data for training the RT 500. During this initial phase, roaming initiation decisions are deferred until the models within the RT module 500 achieve a satisfactory performance score during training.

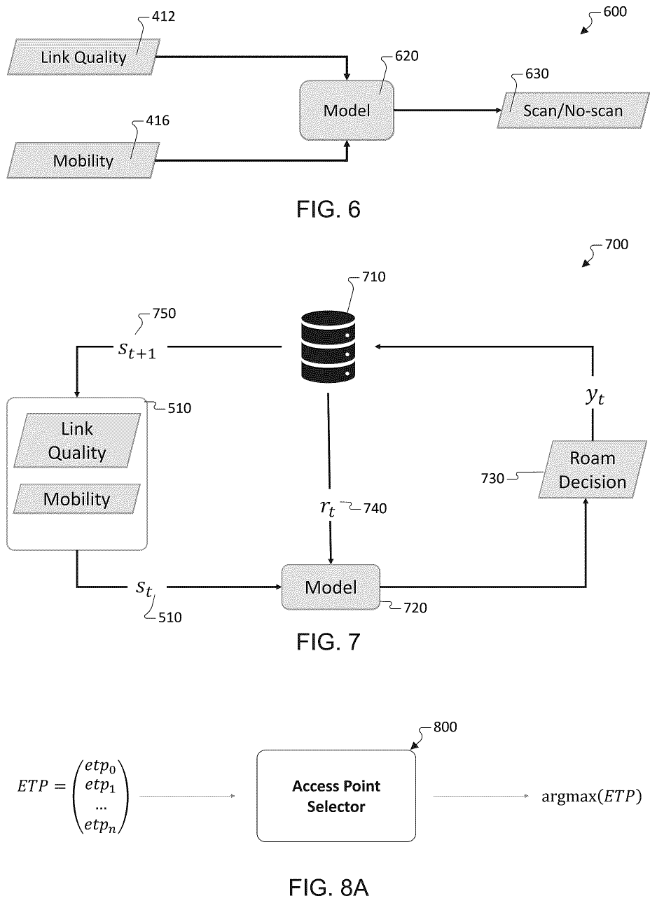

Table 1, FIG. 6, and FIG. 7 illustrate that the RT can be implemented using one or more of the following approaches: Rule-Based System, Supervised Learning, or Reinforcement Learning (RL). Table 1 illustrates a data structure of an example RT module that implements a Rule-Based System according to embodiments of this disclosure. FIG. 6 illustrates an example RT module that implements a Supervised Learning system 600 according to embodiments of this disclosure. FIG. 7 illustrates an example RT module that implements a Reinforcement Learning (RL) system 700 according to embodiments of this disclosure. These embodiments of the RT module shown in Table 1 and FIGS. 6-7 are for illustration only, and other embodiments could be used without departing from the scope of this disclosure.

Referring to Table 1, the Rule-Based System uses predefined rules to monitor link quality metrics and initiate roaming. Specifically, the Rule-Based System includes a conditional parameter, which can be composed of an RSSI threshold denoted as r or a channel contention level threshold denoted as a, both a and r. The RSSI threshold r is a tunable parameter that can have a default value such as −65 dBm. The channel contention level threshold a is a tunable parameter that can have a default value such as 0.55. The tunable parameters enable the RT module to detect whether RSSI is less than the threshold r (RSSI<r) and whether the ratio of CCA to RO is greater than the threshold

$$a ( \frac{CCA}{RO} > a ) .$$

When a roaming trigger is activated under the Rule-Based System, the RT module tunes the conditional parameter as follows. If the currently connected AP is deemed the best option, the conditional parameter (RSSI or CCA/RO) is increased. If a better AP is identified compared to the currently connected AP, the conditional parameter remains unchanged.

When roaming is not triggered under the Rule-Based System, the RT module tunes the conditional parameter as follows. If the currently connected AP is deemed the best option, the conditional parameter remains unchanged. a better AP is identified compared to the currently connected AP, the conditional parameter is decreased.

TABLE 1
Data Structure of the Rule-Based System of an RT module

| | | | |
|---|---|---|---|
| SSI Dₓ | BSSI D₀ | . . . | BSSI Dₙ |
| RSSI | r₀ | . . . | rₙ |
| CCA/RO | a₀ | . . . | aₙ |

Referring to FIG. 6, the RT module implements the Supervised Learning system 600 in which the location-specific model is a binary classifier 620 trained using a supervised learning paradigm. In this embodiment, the binary classifier 620 and its output 630 represent the location-specific model 520 and its trigger decision 530 of FIG. 5, respectively.

In this embodiment, the binary classifier 620 labels data into two categories for training, as shown in Table 2.

TABLE 2
Classes that a Binary Classifier is trained to output

| Condition | Scan Trigger |
|---|---|
| Better AP exist | 1 |
| Associated AP is best | 0 |

The binary classifier 620 receives inputs including link quality 412 metrics and mobility information 416 (such as mobility context). The binary classifier 620 generates an output 630 that indicates whether to initiate a scan for AP candidates. Algorithms suitable for this binary classifier 620 include linear regression, decision trees, neural networks, and other supervised learning techniques.

Referring to FIG. 7, the RT module implements the Reinforcement Learning (RL) system 700 in which the location-specific model is incorporates an RL agent 720 trained using machine learning techniques, deep learning models, or tabular representations of states and actions. In this embodiment, the RL agent 720 and its roam decision 730 represent the location-specific model 520 and its trigger decision 530 of FIG. 5, respectively. In this embodiment, the RL agent 720 can receive input that is the same current state variable sₜ 510 of FIG. 5.

The RL system 700 includes a simulated environment 710 as a training platform that represents Wi-Fi network 420. The simulated environment 710 includes reward function that is designed as expressed in Equation 1, where y denotes the action taken by the RT model. The set-induction of y is expressed in Equation 2. Using this reward function, the RL agent 720 receives a reward rₜ 740 per roam decision (yₜ) 730 output.

$$R = \{ \begin{matrix}1 if y \to better performance \\ - 1 if y \to lower performance\end{matrix} \qquad ( 1 )$$

$$y ∈ A with A = \{ \begin{matrix}1 ≡ to roam \\ 0 ≡ not to roam\end{matrix} \qquad ( 2 )$$

Various RL methods can be used to train the RL agent, including: Value-Based Methods (e.g., Q-learning), Policy-Based Methods (e.g., REINFORCE), Hybrid Methods (e.g., Actor-Critic algorithms). The reward 740 is good reward such as a positive value if the roam decision (yₜ) 730 output is correct. but the reward 740 is a bad punishment such as a negative value if the roam decision (yₜ) 730 output is wrong. For example, the RL agent 720 receives a good reward (rₜ=1) 740 corresponding to the current state variable sₜ 510 if the RL agent 720 generates a decision 730 to roam (yₜ=1) based on the current state variable sₜ 510, and if the next state variable (sₜ+1) 750 represents a better performance (such as a higher data rate in the link quality) after completing the roam(i.e., after the UE has connected to a different AP) compared to the previous state variable sₜ 510. However, the RL agent 720 receives a punishing reward (rₜ=−1) 740 corresponding to the current state variable sₜ 510 if the RL agent 720 generates a decision 730 to roam (yₜ=1) based on the current state variable sₜ 510, and if the next state variable (sₜ₊₁) 750 represents a worse performance (such as a lower data rate) compared the previous state variable sₜ510. If the if the RL agent 720 generates a decision 730 to not roam (yₜ=0), then the simulated environment 710 determines a next state variable (sₜ₊₁) 750 that represents a performance of the UE that stays connected to the currently-connected AP.

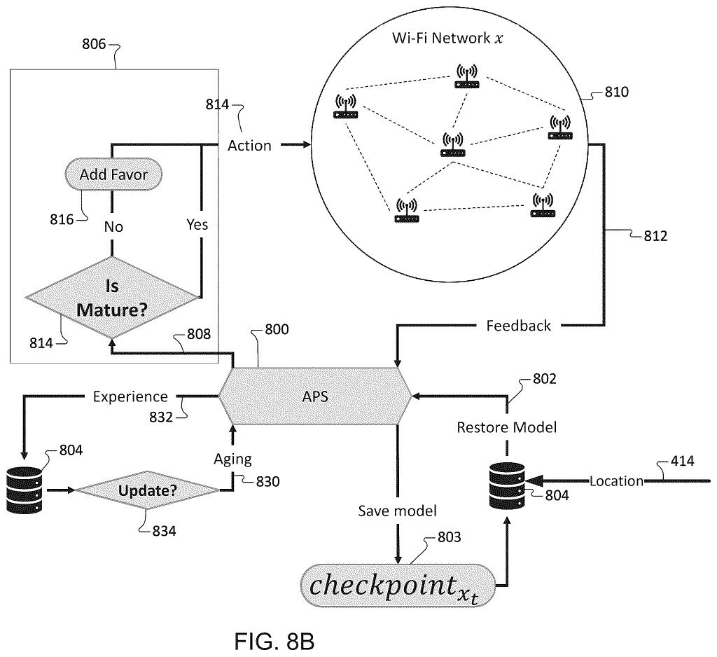

FIG. 8A and FIG. 8B are together referred to as FIG. 8. FIG. 8 illustrates an access point selector module 800 according to embodiments of this disclosure. The embodiment of the APSM 800 shown in FIG. 8 is for illustration only, and other embodiments could be used without departing from the scope of this disclosure.

The APSM 800 is activated upon the initiation of a roaming event, for example, activated only in response to a decision to roam (yₜ=1) 432. The APSM 800, after being activated, receives input that is a combination of. Link Quality 416 metrics and a shortlist 442 of IDs of the top n APs. For example, upon receiving the location information 414, the APSM 800 selects a location-specific model 802 from a model storage 804 within the APSM 800. If it is determined that location information 414 is an unfamiliar location, then the APSM 800 generates new model 803 for the unfamiliar location and saves it with a link to the current location information (within the current state variable sₜ) in the model storage 804.

Another input that the APSM 800 receives is Wi-Fi scan results, which can be referred to as output possibilities. The number of output possibilities 0 corresponds to the number of potential Basic Service Set Identifiers (BSSIDs). By default, 0 is set to handle up to 50 BSSIDs. If the actual number of BSSIDs exceeds 0, the limit is incrementally increased by batches of 50 to accommodate the additional identifiers.

A primary function of the APSM 800 is to determine and select an optimal AP for the UE to transition to. The APSM 800 produces the ID of a selected AP 450 to which the UE should roam. Upon triggering a Wi-Fi scan to be conducted, the APSM 800 ranks the best n APs based on their estimated throughput (ETP) performance metric. The ETP performance metric is calculated according to the methodology specified in the IEEE 802.11 standard document, as shown in Equation 3.

$$EstimatedThroughput = \frac{{EST}_{AirtimeFractionDir} \times {MPDU}_{pPPDU} \times A\_MSDU \_B \times 8}{\begin{matrix}( CW min / 2 + AIFSN [ AC ] ) \times aSlotTime + 2 \times SIFS + \\ {BA\_PPDU}_{Dur} + {PPDU}_{Dur} + {OtherOverhead}_{Dur}\end{matrix}} ( R - 1 ) \qquad ( 3 )$$

Some embodiments of the APSM 800 implements a rule-based system that selects the optimal AP having a greatest ETP performance from among the shortlist. FIG. 8A illustrates the APSM 800 of FIG. 4A implementing a rule-based system. The APSM 800 receives a set of Estimated Throughput (ETP) {etp₀, etp₁, etp₂, etp₃, . . . etpₙ} that respectively correspond to the set of Wi-Fi access points {AP0, AP₁, AP₂, AP₃, . . . APₙ} overlapping at the location of the IWR system 400 (for example, the location of the UE in FIG. 4B). The indices of set of ETP that the APSM 800 can be the identifiers of the list AP candidates 440 within range. The APSM 800 processes the received set of ETP through an argmax operation, and thereby generates an index of the maximum value in the set of ETP, rather than the maximum value itself. This index, which is output from the argmax operation, can be an identifier of the optimal AP candidate 450.

FIG. 8B illustrates the APSM 800 implementing an ML-based model, as described further in this disclosure. Similar to the RT module 500 that is dormant during its initial phase, the APSM 800 undergoes an initial maturation phase 806. During this phase 806, the APSM 800 prioritizes selecting APs with the highest ETP values of performance metric. This prioritization is achieved by assigning higher probability weights to outputs 808 corresponding to APs with superior ETP scores within the APS model.

The APSM 800 can be a machine learning model implemented using On-Policy Reinforcement Learning (RL) technique, such as REINFORCE or Actor-Critic algorithms. This RL technique enables the APSM 800 to adaptively learn and optimize its decision-making over time. The APSM 800 implements an RL technique that includes a simulated environment 810, which can be a training platform similar to the simulated environment 710 of FIG. 7. The RL-based simulated environment 810 includes reward function as expressed in Equation 4, where the reward factors are estimated throughput (ETP), handover delay denoted as d and measured in milliseconds, and Internet accessibility. The simulated environment 810 provides a reward variable 812 as feedback input to the APSM 800, and the value of reward variable 812 is calculated according to the reward function of Equation 4.

$$R ( s , a , {s}^{′} ) = {α}_{ETP} * \% Change ( ETP ) + {α}_{D} * D = \text{.9} * 100 * \frac{{ETP}_{{s}^{′}} - {ETP}_{s}}{{ETP}_{s}} + \text{.1} * D \qquad ( 4 )$$

Equation 5 expresses reward points associated with the factor of ETP. Equation 6 expresses that the weight of the ETP can be 0.9.

$$\% Change ( ETP ) = 100 * \frac{{ETP}_{{s}^{′}} - {ETP}_{s}}{{ETP}_{s}} \qquad ( 5 )$$

$${α}_{ETP} = 0.9 \qquad ( 6 )$$

The handover delay factor can be one selected from among three categories: best, good, and bad. Equation 7 expresses reward points associated with the factor of handover delay d. Equation 8 expresses that the weight of the handover delay can be 0.1.

$$D = \{ \begin{matrix}10 if d \leq 100 ms \\ 0 if 100 ms < d \leq 200 ms \\ - 10 if d > 200 ms\end{matrix} \qquad ( 7 )$$

$${α}_{D} = 0.1 \qquad ( 8 )$$

Equation 9 expresses reward points associated with the factor Internet accessibility, where if the selected AP does not provide internet access, the reward is penalized with a negative value.

$$R = - 20 \qquad ( 9 )$$

The APSM 800 executes both initial maturation phase 806 and the simulated environment 810 to generate the reward variable 812. As an example use case, initially when the APSM 800 is activated, AP candidates are prioritized such that the AP having the highest ETP score with weighted probability is selected as the optimal AP. At block 814, if APSM 800 determines that the new model 803 is mature (sufficiently trained) such that performance of the new model 803 satisfies a performance threshold, then the initial maturation phase 806 ends thereby skipping procedure of block 816. By skipping block 816, the output 808 from the not-yet-mature APSM model becomes the action 818 to roam or not roam to the optimal AP with the actual Wi-Fi network 420 (instead of the simulated environment 810). In other words, when the ML-based model within the APSM 800 is still in the training phase or re-training phase, then the output 808 is generated by using the rule-based system of FIG. 8A. Alternatively at block 816, if one AP has a high ETP performance metric, then the APSM 800 will add favor (for example, inject the probability into the action 818). Each action 818 can be associated with a softmax function. Each action 818 can be a vector representing all of the access points at this geographical location (identified by location information 414), and each element of the vector is a respective ETP scores corresponding to a respective AP at this geographical location. An example softmax function can define a corresponding set of weighted probabilities {0.7, 0.2, and 0.1} that together equal to 100%, and the softmax function can be associated with a set of actions {ETP₁=10 MBps, ETP₂=7.3 MBps, ETP₃=7.0 MBps}. That is, the 3 actions within the set of actions can represent a 3 AP candidates ranked from highest to lowest ETP score. A different set of weighted probabilities and a different set of actions can be used without departing from the scope of this disclosure.

Another input to the APSM 800 is aging 830, which can be a determination that one or more models within the model storage 804 needs to be updated due to a last experience 832 than a recency threshold, as determined at block 834. The last experience 832 can be a set of inputs (410) and its timestamp of being inputted and/or processed through the one or more models within the model storage 804.

Table 3 illustrates a data structure of a Data Platform (DP) module 900 according to embodiments of this disclosure. The DP module 900 collects and organizes data to map all Basic Service Set Identifiers (BSSIDs) within a given Wi-Fi network identified by its Service Set Identifier (SSID). During the learning phase of the DP module 900, data collection sessions are initiated frequently to capture comprehensive network information. The collected data is stored in a structured format as shown in Table 3, where: n is the number of BSSIDs in the Wi-Fi network, and m is the number of timesteps.

TABLE 3
Data Structure of Training Data Platform module

| | | | |
|---|---|---|---|
| i\t | 0 | . . . | m − 1 |
| BSSI D₀ | rssi_{i=0; t=0} | . . . | rssi_{i=0; t=m-1} |
| . . . | . . . | . . . | . . . |
| BSSI Dₙ₋₁ | rssi_{i=n; t=0} | . . . | rssi_{i=m-1; t=m-1} |

At each time step the following information is also collected: RSSI_{BSSID}; user's mobility status; and the following are metrics that are collected from the currently associated AP: RSSI_{CAP}, ETP, CAA, RO, and D that denotes the packet delay. The RSSI_{BSSID} denotes the Received Signal Strength Indicator of the scanned BSSID. The user's mobility status is derived from IMU sensors or other mobility context inputs.

For any APs not detected in results of a Wi-Fi scan, the corresponding RSSI values are assigned a default value of −100 to indicate unreachability.

As the IWR system matures over time, the frequency of data collection sessions decreases, with the DP module 900 collecting data only occasionally. This approach reduces overhead while ensuring that the IWR system remains updated with relevant network dynamics.

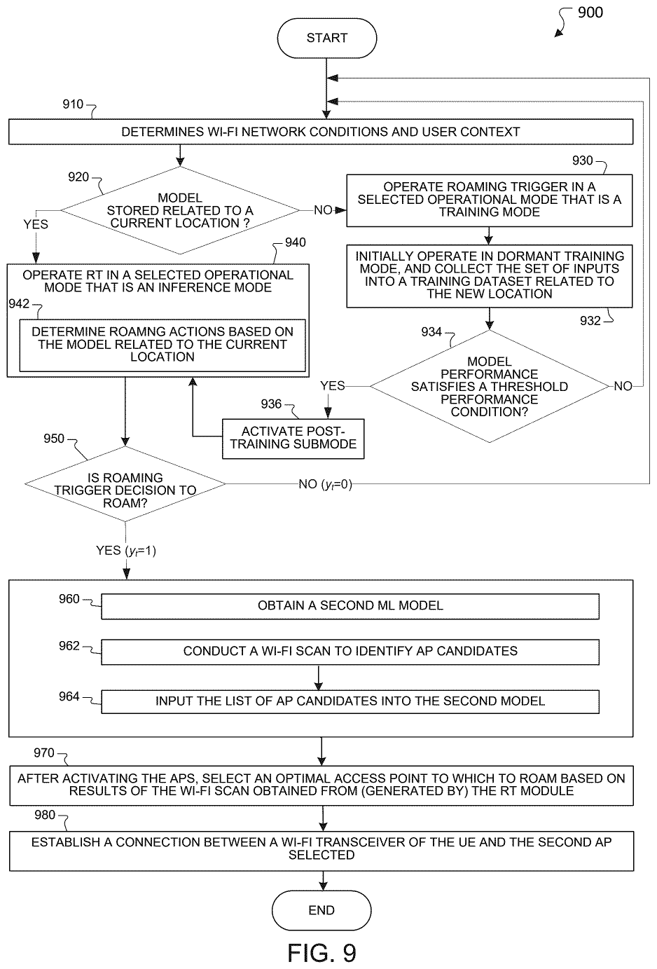

FIG. 9 illustrates a method 900 for intelligent Wi-Fi roaming using machine learning and dynamic decision in accordance with an embodiment of this disclosure. The method 900 enables a Wi-Fi mobile station (STA) to make efficient roaming and seamless handoff in dense environments with multiple overlapping Wi-Fi access points. The embodiment of the method 900 shown in FIG. 9 is for illustration only, and other embodiments could be used without departing from the scope of this disclosure. The method 900 is implemented by an electronic device, such as any among the plurality of STAs 111-114 of FIG. 1 or the UE 304 of FIG. 3. More particularly, the method 900 could be performed by a processor 240 of the STA 111 executing the Intelligent Wi-Fi Roamer system in the OS program 261 and/or application 962. For ease of explanation, the method 900 is described as being performed by the processor 240 using the IWR system 400 of FIGS. 4-8B.

At the start of the method 900, the processor 240 establishes or has already established a connection to a Wi-Fi network, such as the network 100 of FIG. 1 or Wi-Fi network 420 of FIG. 4. At block 910, the processor 240 determines Wi-Fi network conditions and user context based on a received a set of inputs. More particularly, the processor 240 receives a set of inputs including: a link quality, a location information, and a mobility context information. The processor 240 can determine current connectivity environment and movement of the UE based on the received set of inputs.

At block 920, the processor 240 (using the RT 500) obtains a first machine learning model 520 related to the location information. More particularly, the processor 240 determines whether a model related to (for example, linked to, corresponding to) a current location of the UE is stored in a model storage 502, thereby determining whether the current location of the UE is familiar or unfamiliar. Here, the processor 240 determines that a current location of the UE is a familiar location if the RT model storage 502 includes a model 520 corresponding to the current location, which the processor 240 selects to be used to determine roaming actions at the current location. The method 900 proceeds to block 940 if the RT model storage 502 includes the location information 414 linked to a first ML model 520. Alternatively, the processor 240 determines that the current location of the UE is an unfamiliar new location if the RT model storage 502 does not include any model that corresponds to the current location, then the method 900 proceeds to block 930.

The RT model storage 502 can be stored locally in a memory 260 of the UE. The model storage 502 can include multiple geographic location-specific models, such as a first model related to a home location, a second model related to an enterprise workplace location, a third model related to a school location of a user, and other models related to other locations familiar to the user's UE.

At blocks 930 and 940, the processor 240 selects an operational mode of the RT 500 based on the determination result made at block 920. The operational mode is selected from among an inference mode and a training mode. This is a binary selection when the RT 500 is configured to operate across two operational modes.

At block 930, the processor 240 selects the training mode as operational mode of the RT 500, based on the determination that the RT model storage 502 does not store a model related to the current location. That is, the processor 240 operates the RT 500 in the selected operational mode that is the training mode. In some embodiments, operating in the training mode includes applying a rules-based algorithm to determine roaming actions. Examples of roaming actions include: a determination to roam or a determination to not roam.

The training mode includes multiple submodes: dormant submode, active training submode, and post-training submode. At block 932, the processor 240 initially operates in the dormant submode upon activating the training mode at the new location. While operating in the dormant submode, the processor 240 collects the set of inputs into a training dataset related to the new location. For example, the processor 240 can create a location-specific training dataset related to the new location, and add the set of inputs repeatedly collected over time at the new location.

At block 934, the processor 240 constructs, trains, tests, and evaluates a new model related to the new location. In some embodiments, to make sure that a training dataset is sufficient to begin a training process, the processor 240 determines whether the number of sets of inputs collected (or number of training repetitions) in the training dataset exceeds a threshold that represents a minimum amount of training data adequate to begin training a model, and then after the threshold is exceeded, enables the processor to initiate training of a newly constructed location-specific model.

In some embodiments, the processor 240 can implement a supervised learning technique as the training process to train the model, for example as shown FIG. 6. In some embodiments, the processor 240 can implement a self-training process to train the model, for example as shown in RL technique of FIG. 7. To evaluate the new model, the processor 240 obtains measurements of a model performance (yₜ) from the tests, which the processor 240 then compares to a threshold condition that defines good performance (threshold performance condition). The processor 240 can continue to train, test, and evaluate a new model until the model performance (yₜ) satisfies the threshold performance condition. In some embodiments, the threshold performance condition is satisfied if the measurements of model performance are greater than or equivalent to optimal performance metrics. After the new model has been created, and before the new model has achieved optimal performance (i.e., before the threshold performance condition is satisfied), the processor 240 disables the inference mode, preventing RT 500 from prematurely using the new model to determine roaming actions.

At block 936, the processor 240 activates the post-training submode when the models achieve optimal performance, thereby enabling the processor 240 to switch to inference mode (i.e., enabling roaming initiation). In some embodiments, the post-training submode can include both the training mode in an OFF state and the inference mode in an ON state. The post-training submode, when activated, overrides any roaming actions that another rules-based algorithm determines. For example, when the UE 304 returns to a location related to a model that is already stored in the model storage 502, then the other rules-based algorithm can be ignored if allowed to execute or can be disabled.

At block 940, the processor 240 selects the inference mode as operational mode of the RT 500, based on the determination that the RT model storage 502 stores a first ML model 520 related to the current location. Particularly, the processor 240 switches the RT operational mode and operates in the inference mode, thereby determining (at block 942) roaming actions based on the model related to the current location.

At block 942, the set of inputs 410 are processed through the first model related to the current location that has been trained to determine roaming actions. As an example shown in FIG. 5, the set of inputs corresponding to a current time is illustrated as a current state variable sₜ, and the processor 240 inputs the current link quality 412 and current mobility context information 416 into the selected model 520. The model 520 generates and outputs a trigger decision (yₜ) 430. At this stage, the processor 240 has not yet established a connection to any second access point (such as AP2 303 of FIG. 3) within the Wi-Fi network 420, and instead, the processor 240 has determined to prepare itself to establish a new connection with a second access point.

The method executed by RT module 500 in FIGS. 5-7 enables the IWR system 400 with a UE to determine whether to roam and when to roam, for example, whether to switch from an established connection with the AP 101 or 301 to connect to the AP 103 or 303 of FIG. 1 or FIG. 3.

At block 950, the processor 240 determines a roaming action 430 from among an action to roam 432 from a first access point (AP) 301 currently connected to a user equipment 306 (UE) to a second AP 303 or an action to not roam 434, based on providing the set of inputs 510 to the first ML model 520. More particularly, the processor 240 determines whether the trigger decision 430 is decision to roam (yₜ=1), and controls activation of an access point selector 800 based on the value of the roaming trigger decision yₜ. The roaming trigger decision yₜ 430, when a first indication (yₜ=1) is received by the APSM 800, activates the APSM 800 to conduct a Wi-Fi scan. But, the second indication (yₜ=0) to not roam does not trigger the APSM 800, and the method 900 restarts.

Blocks 960-964 represent a phase in which the IWR system 400 prepares to establish a new connection with a different AP than the currently-connected first AP. Blocks 970-974 represent a subsequent phase in which the IWR system 400 actually establishes a new connection with a second AP selected by using machine learning and dynamic decision making.

At block 960, the processor 240, after activating the APSM 800, obtains a second ML model related to the location information 414, based on a determination that the roaming action is the action to roam 432. If the location information 414 corresponds to a familiar location, then the second ML model 802 can be selected from the model storage 804 within the APSM 800. If the location information 414 corresponds to an unfamiliar location, then the second model can be a newly generated model 803 that the SPSM 800 creates and adds to the model storage 804 with a new link to the current location information 414. This second ML model 800 is linked to the current location 414 and referred to as the APSM 800.

At block 962, the processor 240, after activating the APSM 800, conducts a Wi-Fi scan to generate a list of AP candidates. For example, as shown in FIG. 8A, the ETP vector can be the list of AP candidates 440 or can be a shortlist 442.

At block 964, the processor 240 provides the list of AP candidates as inputs to the second ML model 800 to select an AP candidate 450 as the second AP from among the list of AP candidates.

At block 970, processor 240 selects the AP candidate as the second AP from among the list of AP candidates by processing the list of AP candidates through the second ML model 800, 802 selected. The APSM 800 (i.e., second ML model) ranks the AP candidates based on ETP value. The processor 240 can select the AP candidate as the second AP by using rule-based system within the APSM 800 of FIG. 8A. The processor 240 can select the AP candidate as the second AP by using the initial maturation phase 806 of the ML-based model system of FIG. 8B. After the initial maturation phase 806 has ended and is skipped, the processor 240 can select the AP candidate as the second AP by using the simulated environment 810 in a reinforcement learning technique that provides the reward variable 812 as feedback.

At block 980, the processor 240 establishes a connection between a Wi-Fi transceiver of the UE and the second AP selected.

In some embodiments of the method 900, the processor 240 obtains the first ML model includes: using the location information to query a model storage that includes multiple location-specific ML models respectively linked to different location identifiers. When a query result is that the model storage does not include the location information, obtaining the first ML model includes: generating, as the first ML model, a new location-specific ML model linked to the location information; and training the new location-specific ML model until a performance of the new location-specific ML model satisfies a threshold performance condition that switches an operational mode of the new location-specific ML model to a post-training inference mode.

In some embodiments of the method 900, the processor 240 determines a roaming action by: when the operational mode is not the post-training inference mode, employing a rule-based system that generates the determination that the roaming action is the action to roam based on a tunable parameter compared to the link quality, the link quality including received signal strength indicator (RSSI) or a channel contention level. Alternatively, and when the operational mode is the post-training inference mode, determining a roaming action can further comprise employing a reinforcement learning (RL) technique or a binary classifier in supervised learning technique. When the operational mode is the post-training inference mode, determining a roaming action further comprises training the new location-specific ML model by employing the supervised learning technique. When the operational mode is the post-training inference mode, determining a roaming action further comprises training the new location-specific ML model by employing the RL technique with a reward function.

In some embodiments of the method 900, the processor 240 uses the second ML model to select the AP candidate by: ranking the list of AP candidates based on an Estimated Throughput (ETP) performance metric to include a predetermined number of AP candidates in a shortlist from among the list of AP candidates; generating an ETP score for each AP candidate in the shortlist by assigning greater probability weights to AP candidates corresponding to greater ETP performance metrics; and selecting the AP candidate based on the ETP score.

In some embodiments, the method 900 includes training the second ML model using a reinforcement learning technique with a reward function that is based on: an Estimated Throughput (ETP) performance metric; a handover delay; and an Internet accessibility.

Although FIG. 9 illustrates an example method 900 for intelligent Wi-Fi roaming using machine learning and dynamic decision, various changes may be made to FIG. 9. For example, while shown as a series of steps, various steps in FIG. 9 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by processor, the method comprising:
determining Wi-Fi network conditions and user context based on a received a set of inputs including: a link quality, a location information, and a mobility context information;
obtaining a first machine learning (ML) model related to the location information;
determining a roaming action from among an action to roam from a first access point (AP) currently connected to a user equipment (UE) to a second AP or an action to not roam, based on providing the set of inputs to the first ML model;
obtaining a second ML model related to the location information, based on a determination that the roaming action is the action to roam;
providing a list of AP candidates as inputs to the second ML model to select an AP candidate as the second AP from among the list of AP candidates; and
establishing a connection between a Wi-Fi transceiver of the UE and the second AP selected.

2. The method of claim 1, wherein obtaining the first ML model includes:
using the location information to query a model storage that includes multiple location-specific ML models respectively linked to different location identifiers; and
when a query result is that the model storage does not include the location information:
generating, as the first ML model, a new location-specific ML model linked to the location information; and
training the new location-specific ML model until a performance of the new location-specific ML model satisfies a threshold performance condition that switches an operational mode of the new location-specific ML model to a post-training inference mode.

3. The method of claim 2, wherein determining a roaming action further comprises:
when the operational mode is not the post-training inference mode, employing a rule-based system that generates the determination that the roaming action is the action to roam based on a tunable parameter compared to the link quality, the link quality including received signal strength indicator (RSSI) or a channel contention level; and
when the operational mode is the post-training inference mode, employing a reinforcement learning (RL) technique or a binary classifier in supervised learning technique.

4. The method of claim 3, further comprising:
when the operational mode is the post-training inference mode, training the new location-specific ML model by employing the supervised learning technique.

5. The method of claim 3, further comprising:
when the operational mode is the post-training inference mode, training the new location-specific ML model by employing the RL technique with a reward function.

6. The method of claim 1, further comprising selecting the AP candidate by:
ranking the list of AP candidates based on an Estimated Throughput (ETP) performance metric to include a predetermined number of AP candidates in a shortlist from among the list of AP candidates;
generating an ETP score for each AP candidate in the shortlist by assigning greater probability weights to AP candidates corresponding to greater ETP performance metrics; and
selecting the AP candidate based on the ETP score.

7. The method of claim 1, further comprising training the second ML model using a reinforcement learning technique with a reward function that is based on:
an Estimated Throughput (ETP) performance metric;
a handover delay; and
an Internet accessibility.

8. A user equipment (UE) comprising:
a Wi-Fi transceiver;
a processor operably connected to the Wi-Fi transceiver, the processor configured to:
determine Wi-Fi network conditions and user context based on a received a set of inputs including: a link quality, a location information, and a mobility context information;
obtain a first machine learning (ML) model related to the location information;
determine a roaming action from among an action to roam from a first access point (AP) currently connected to the UE to a second AP or an action to not roam, based on providing the set of inputs to the first ML model;
obtain a second ML model related to the location information, based on a determination that the roaming action is the action to roam;
provide a list of AP candidates as inputs to the second ML model to select an AP candidate as the second AP from among the list of AP candidates; and
establish a connection between the Wi-Fi transceiver and the second AP selected.

9. The UE of claim 8, wherein to obtain the first ML model, the processor is further configured to:
use the location information to query a model storage that includes multiple location-specific ML models respectively linked to different location identifiers; and
when a query result is that the model storage does not include the location information:
generate, as the first ML model, a new location-specific ML model linked to the location information; and
train the new location-specific ML model until a performance of the new location-specific ML model satisfies a threshold performance condition that switches an operational mode of the new location-specific ML model to a post-training inference mode.

10. The UE of claim 9, wherein to determine a roaming action, the processor is further configured to:
when the operational mode is not the post-training inference mode, employ a rule-based system that generates the determination that the roaming action is the action to roam based on a tunable parameter compared to the link quality, the link quality including received signal strength indicator (RSSI) or a channel contention level; and
when the operational mode is the post-training inference mode, employ a reinforcement learning (RL) technique or a binary classifier in supervised learning technique.

11. The UE of claim 10, wherein the processor is further configured to:
when the operational mode is the post-training inference mode, train the new location-specific ML model by employing the supervised learning technique.

12. The UE of claim 10, wherein the processor is further configured to:
when the operational mode is the post-training inference mode, train the new location-specific ML model by employing the RL technique with a reward function.

13. The UE of claim 8, wherein to select the AP candidate, the processor is further configured to:
rank the list of AP candidates based on an Estimated Throughput (ETP) performance metric to include a predetermined number of AP candidates in a shortlist from among the list of AP candidates;
generate an ETP score for each AP candidate in the shortlist by assigning greater probability weights to AP candidates corresponding to greater ETP performance metrics; and
select the AP candidate based on the ETP score.

14. The UE of claim 8, wherein the processor is further configured to train the second ML model using a reinforcement learning technique with a reward function that is based on:
an Estimated Throughput (ETP) performance metric;
a handover delay; and
an Internet accessibility.

15. A non-transitory computer readable medium embodying a computer program, the computer program comprising computer readable program code that when executed causes a processor of an electronic device to:
determine Wi-Fi network conditions and user context based on a received a set of inputs including: a link quality, a location information, and a mobility context information;
obtain a first machine learning (ML) model related to the location information;
determine a roaming action from among an action to roam from a first access point (AP) currently connected to a user equipment (UE) to a second AP or an action to not roam, based on providing the set of inputs to the first ML model;
obtain a second ML model related to the location information, based on a determination that the roaming action is the action to roam;
provide a list of AP candidates as inputs to the second ML model to select an AP candidate as the second AP from among the list of AP candidates; and
establish a connection between a Wi-Fi transceiver of the UE and the second AP selected.

16. The non-transitory computer readable medium of claim 15, wherein the program code that when executed causes the processor to obtain the first ML model further comprises program code that when executed causes the processor to:
use the location information to query a model storage that includes multiple location-specific ML models respectively linked to different location identifiers; and
when a query result is that the model storage does not include the location information:
generate, as the first ML model, a new location-specific ML model linked to the location information; and
train the new location-specific ML model until a performance of the new location-specific ML model satisfies a threshold performance condition that switches an operational mode of the new location-specific ML model to a post-training inference mode.

17. The non-transitory computer readable medium of claim 16, wherein the program code that when executed causes the processor to determine a roaming action further comprises program code that when executed causes the processor to:
when the operational mode is not the post-training inference mode, employ a rule-based system that generates the determination that the roaming action is the action to roam based on a tunable parameter compared to the link quality, the link quality including received signal strength indicator (RSSI) or a channel contention level; and
when the operational mode is the post-training inference mode, employ a reinforcement learning (RL) technique or a binary classifier in supervised learning technique.

18. The non-transitory computer readable medium of claim 17, further containing program code that when executed causes the processor to:
when the operational mode is the post-training inference mode, train the new location-specific ML model by employing the supervised learning technique.

19. The non-transitory computer readable medium of claim 17, further containing program code that when executed causes the processor to:
when the operational mode is the post-training inference mode, train the new location-specific ML model by employing the RL technique with a reward function.

20. The non-transitory computer readable medium of claim 15, wherein the program code that when executed causes the processor to select the AP candidate further comprises program code that when executed causes the processor to:
rank the list of AP candidates based on an Estimated Throughput (ETP) performance metric to include a predetermined number of AP candidates in a shortlist from among the list of AP candidates;
generate an ETP score for each AP candidate in the shortlist by assigning greater probability weights to AP candidates corresponding to greater ETP performance metrics; and
select the AP candidate based on the ETP score.
